(19) United States
(12) Patent Application Publication
(10) Pub. No.: US 2024/0336348 A1
(43) Pub. Date: Oct. 10, 2024

(54) AIRPLANE WING WITH A STRUCTURALLY-INTEGRATED RECHARGEABLE POWER SOURCE

(71) Applicant: The Boeing Company, Arlington, VA (US)

(72) Inventor: Jens Bold, Munich (DE)

(73) Assignee: The Boeing Company, Arlington, VA (US)

(21) Appl. No.: 18/296,792

(22) Filed: Apr. 6, 2023

(51) Int. Cl. B64C 3/32; B32B 3/30; B32B 15/04; B32B 15/20; B64C 3/18; B64C 3/20; B64C 3/26; B64D 27/24; B64D 27/26; H01M 8/04082; H01M 8/2465; H01M 10/0525; H01M 16/00; H01M 50/249; H01M 50/278

(52) U.S. Cl. CPC B64C 3/32; B64C 3/26; B64D 27/355; B64D 27/357; H01M 8/04201; H01M 8/2465; H01M 10/0525; H01M 16/006; H01M 50/224; H01M 50/249; H01M 50/278; H01M 2008/1095; H01M 2220/20

(57) ABSTRACT

This disclosure relates to power sources that are structurally integrated with an airplane wing. The power sources include rechargeable batteries, such as Ni-Cd, NiMH, and/or Li-ion batteries; and/or hydrogen fuel cells. The power sources can be located on the airplane wing, inside of the wing, and/or located on the bottom of the wing, and combinations thereof. The airplane wing can be made of a metallic structural material or a composite structural material. Layers of a Li-ion battery can conformally overlay the upper metallic structural skin of a metallic wing, and the electrically-conductive metallic airplane wing itself acts as a cathode (or anode) of the battery. The airplane wing can be made of laminated sheets of carbon-fiber composites (CFCs). The power sources can be sandwiched inside of an upper and/or a lower section of the composite airplane wing. Lithium-ion batteries can be connected in series to provide a greater voltage.

### INTRODUCTION

This disclosure relates to structurally-integrated rechargeable power sources, such as structurally-integrated rechargeable batteries or rechargeable fuel cells, which are structurally-integrated with an airplane wing of an aerospace structure (e.g., an airplane). The structurally-integrated rechargeable power source can comprise, for example, a rechargeable Lithium-ion battery and/or a rechargeable hydrogen fuel cell.

Demonstration “green” airplanes are being developed that utilize all-electrical power sources to drive the engines and other electrical systems in an airplane. A traditional approach is to mount the electrical power source inside the fuselage of an airplane. However, the extra weight of the power source (e.g., batteries or fuel cells) located inside of the fuselage causes additional weight that the wings must hold and support, while taking up valuable space inside of the fuselage.

A need exists for a structurally-integrated aerospace structure that structurally-integrates the rechargeable power sources with an airplane wing. Against this background, the present disclosure was created.

### SUMMARY

The present disclosure relates generically to a structurally-integrated rechargeable power source that is structurally-integrated with an aerospace airplane wing. The rechargeable power source includes rechargeable batteries, such as rechargeable Ni-Cd (Nickel-Cadmium), Nickel-Metal-Hydride (NiMH), and/or Lithium-ion (Li-ion) batteries; and/or a rechargeable hydrogen fuel cell. In other embodiments, rechargeable Metal-Air batteries can be used (e.g., Ti-Air, Zn-Air, Al-Air, Fe-Air, and/or Si-Air batteries).

In a first embodiment, the airplane wing is made of a metallic structural material (e.g., aluminum alloy) and has an upper metallic structural skin and a lower metallic structural skin. A structurally-integrated rechargeable battery conformally overlays the upper and/or lower metallic structural skin, and the electrically-conductive metallic airplane wing structure itself acts as a cathode (or anode) of the structurally-integrated rechargeable battery. The structurally-integrated rechargeable battery makes innovative use of the upper (and/or lower) metallic structural skin as the first conductor of the structurally-integrated rechargeable battery. The structurally-integrated rechargeable battery includes six stacked layers, including: first, second, third, fourth, fifth and sixth layers in a possible embodiment. The first layer in this embodiment includes a first conductor (which includes, for example, aluminum or an aluminum alloy) that is the upper (and/or lower) metallic structural skin of the airplane wing. The second layer is directly attached to the upper (and/or lower) metallic structural skin and includes a first electrode (which includes, for example, a Lithium-Metal-Oxide electrode). The third layer includes a separator membrane that is located above the second layer. The fourth layer includes a second electrode (which includes, for example, a graphite electrode) that is located above the third layer. The fifth layer includes an electrical conductor (which includes, for example, a copper or copper alloy conductor) that is located above the fourth layer. The sixth layer includes a cover material (which includes, for example, paint or a polymeric material) that covers and protects the second conductor layer. When a charged, structurally-integrated rechargeable battery is connected to an electrical load (e.g., a motor), then electricity flows through the upper (and/or lower) metallic structural skin from the first layer to a fifth layer. The structurally-integrated rechargeable battery includes a Lithium-ion (Li-ion) battery in this exemplary implementation.

In a second embodiment, the airplane wing is a composite airplane wing that is made of multiple, laminated sheets of carbon-fiber composites (CFCs). The composite airplane wing includes an outer composite structural skin and an attached, internal composite structural laminate. The structurally-integrated rechargeable battery is located inside of the composite airplane wing. In this second embodiment, the structurally-integrated rechargeable battery is sandwiched in-between an outer composite structural skin and an attached, internal composite structural laminate layer. The structurally-integrated rechargeable battery includes five multiple, stacked layers, including: first, second, third, fourth, and fifth layers. The first layer in such an embodiment includes a first conductor that is located above (or below) the internal composite structural laminate layer. The second layer includes a first electrode that is located above (or below) the first layer. The third layer includes a separator membrane that is located above (or below) the second layer. The fourth layer includes a second electrode that is located above (or below) the third layer. The fifth layer includes a second electrical conductor that is located above (or below) the fourth layer. Examples of the first conductor includes aluminum, an aluminum alloy, copper or a copper alloy). An example of the first electrode includes a lithium-metal-oxide compound (e.g., for lithium-ion batteries). An example of the second electrode includes a graphite electrode. Examples of the second conductor includes aluminum, an aluminum alloy, copper or a copper alloy. The structurally-integrated rechargeable battery includes a Lithium-ion (Li-ion) battery in this exemplary implementation.

In a third embodiment, the structurally-integrated rechargeable power source is a structurally-integrated rechargeable hydrogen fuel cell that is located inside of a metallic airplane wing. The hydrogen fuel cell includes multiple, stacked layers, including: (1) a first layer including a first, open longitudinal channel for carrying air; (2) a second layer, located above the first layer that includes a first diffusion layer; (3) a third layer, located above the second layer, that includes a first catalyst; (4) a fourth layer, located above the third layer, that includes an electrolyte membrane; (5) a fifth layer, located above the fourth layer, that includes a second catalyst; (6) a sixth layer, located above the fifth layer, that includes a second diffusion layer, and (7) a seventh layer, located above the sixth layer, that includes a second, open longitudinal channel for carrying hydrogen gas. The multiple stacked layers of the hydrogen fuel cell are contained within a sealed rectangular box that is defined on four sides by a pair of separated, non-conductive, longitudinal stringers on two opposite sides, and by upper and lower metallic cover plates on the other two opposite sides. An upper, non-conductive spacer sheet (e.g., glass fiber composite) is located in-between the upper metallic cover plate and the upper metallic skin of the metallic airplane wing. A lower, non-conductive spacer sheet (e.g., glass fiber composite) is located in-between the lower metallic cover plate and the lower metallic skin of the metallic airplane wing. Examples of the first and second catalysts include platinum. Examples of the electrolyte membrane include: a Proton Exchange Material (PEM), a perfluorinated sulfonic acid material (PFSA), graphene, or boron nitride, and/or combinations thereof.

In a fourth embodiment, the rechargeable power source is a structurally-integrated rechargeable hydrogen fuel cell that is located inside of a composite airplane wing. The hydrogen fuel cell includes multiple stacked layers, including: first, second, third, fourth, fifth, sixth, and seventh layers in a possible embodiment. The hydrogen fuel cell includes: (1) a first layer including a first, open longitudinal channel for carrying air; (2) a second layer, located above the first layer that includes a first diffusion layer; (3) a third layer, located above the second layer, that includes a first catalyst; (4) a fourth layer, located above the third layer, that includes an electrolyte membrane; (5) a fifth layer, located above the fourth layer, that includes a second catalyst; (6) a sixth layer, located above the fifth layer, that includes a second diffusion layer, and (7) a seventh layer, located above the sixth layer, that includes a second, open longitudinal channel for carrying hydrogen gas. The multiple, stacked layers of the Hydrogen fuel cell are contained within a sealed rectangular box that is defined on four sides by a pair of separated, non-conductive, longitudinal stringers on two opposite sides, and by upper and lower metallic cover plates on the other two sides. An upper, non-conductive, spacer sheet (e.g., glass-fiber composite) is located in-between the upper metallic cover plate and the upper composite structural skin of the composite airplane wing. A lower, non-conductive, spacer sheet (e.g., glass-fiber composite) is disposed in-between the lower metal cover plate and the lower composite structural skin of the composite airplane wing. An example of the first and second catalyst layers includes platinum. Examples of the electrolyte membrane include: Proton Exchange Material (PEM), a perfluorinated sulfonic acid material (PSFA), graphene, or boron nitride, and combinations thereof.

### BRIEF DESCRIPTION OF THE DRAWINGS

FIG. 1 shows a 3-D perspective view of an example of a structurally-integrated battery module that conformally overlays a top of the upper metallic skin of a metallic airplane wing, according to the present disclosure.

FIG. 2 shows a 3-D perspective view of an example of a structurally-integrated battery module with a shaped second conductor that conformally overlays the upper metallic skin of a metallic airplane wing, according to the present disclosure.

FIG. 3 shows a 3-D perspective view of an example showing a cross-sectional end view of a structurally-integrated battery module that is located inside of an upper section of a composite airplane wing, according to the present disclosure. The close-up view shows an end view of a cross-section of the upper section of the composite airplane wing, including the structural battery located inside of the upper section.

FIG. 4 shows a 3-D perspective view of an example showing a cross-sectional end view of a structurally-integrated, rechargeable, hydrogen fuel cell that is located inside of an upper section of a composite airplane wing, according to the present disclosure. The close-up view shows an end view of a cross-section of the upper section of the composite airplane wing, including the structurally-integrated battery disposed inside of the upper section.

FIG. 5A shows a cross-sectional end view of an example of a structurally-integrated, rechargeable, hydrogen fuel cell that is located inside of an upper section of a composite airplane wing, according to the present disclosure. In the enlarged view, the anode is located above the cathode.

FIG. 5B shows an enlarged, cross-section view of another example of a structurally-integrated, rechargeable, hydrogen fuel cell that is located inside of an upper cross-section of a composite airplane wing, according to the present disclosure. In this example, the anode is located below the cathode.

FIG. 6 shows a schematic cross-sectional end view of a sealed, structural “box” (for holding structurally-integrated, rechargeable, hydrogen fuel cells, not shown).

FIG. 7 shows a 3-D perspective view of an example showing a cross-sectional end view of a structurally-integrated, rechargeable, hydrogen fuel cell and hydrogen pressure tanks that are located inside of a composite airplane wing and oriented along the cord direction, according to the present disclosure.

FIG. 8 shows a 2-D view of an example showing a cross-sectional end view of a structurally-integrated, rechargeable, hydrogen fuel cell module and a hydrogen pressure tank that is located inside of a metallic airplane wing and oriented along the spanwise direction, according to the present disclosure.

FIG. 9A shows a 3-D perspective view of a first example of a shaped (patterned) conductor layer of the conformal, structurally-integrated rechargeable lithium-ion battery from FIG. 2, which provides, for example, 12 V for a group of stacked Li-ion battery cells (which produces 1.2 V per each cell), according to the present disclosure.

FIG. 9B shows a 3-D perspective view of a second example of a shaped (patterned) conductor layer of the conformal, structurally-integrated rechargeable lithium-ion battery from FIG. 2, which provides, for example, 12 V for a group of stacked Li-ion battery cells (which produces 1.2 V per each cell), according to the present disclosure.

FIG. 9C shows a 3-D perspective view of a third example of a shaped (patterned) conductor layer of the conformal, structurally-integrated rechargeable lithium-ion battery from FIG. 2, which provides, for example, 12 V for a group of stacked Li-ion battery cells (which produces 1.2 V per each cell), according to the present disclosure.

FIG. 9D shows a 3-D perspective view of a fourth example of a shaped (patterned) conductor layer of the conformal, structurally-integrated rechargeable lithium-ion battery from FIG. 2, which provides, for example, 12 V for a group of stacked Li-ion battery cells (which produces 1.2 V per each cell), according to the present disclosure.

FIG. 10 shows a 3-D perspective view of an airplane with an airplane wing and structurally-integrated power sources, according to the present disclosure.

### DETAILED DESCRIPTION

The present disclosure relates broadly to rechargeable power sources that are structurally integrated with an airplane wing. The rechargeable power sources can include rechargeable batteries, for example: Nickel-Cadmium (Ni-Cd), Nickel-Metal-Hydride (NiMH), and/or Lithium-ion (Li-ion) batteries, and/or rechargeable hydrogen fuel cells. Both metallic airplane wings and composite airplane wings can be used with the structurally-integrated power sources. The power source can be conformally located on top of, and/or below, an outer skin of a metallic or composite airplane wing. Alternatively, the power source can be located inside of the wing's structure. The wing can be a metallic airplane wing or a composite airplane wing. A hydrogen-fuel cell is characterized herein as being “rechargeable” because the fuel cell is recharged with fresh hydrogen gas and air (oxygen gas) when being used.

The word “composite” means any material comprising fibers embedded in a matrix material (e.g., which includes woven or non-woven carbon, graphite or glass fibers embedded in a cured, thermoset or thermoplastic resin matrix (e.g., epoxy resin)). The word “composite” also includes, for example, glass-fiber reinforced glass composite materials, (which can have, for example, uni-directionally oriented glass fibers or woven or non-woven fiber architectures). The term “structurally integrated” means that the power source has dedicated structural elements that are mechanically coupled to the wing that increases to the wing's overall structural capability. The term “laminate” means two or more individual layers of a fiber-reinforced composite material that is processed to make a single structure comprising the two or more individual layers of fiber-reinforced composite material joined together. The word “conformal” or “conformally” (e.g., a “conformal layer” or a “conformal coating”) means that an outer layer or coating is shaped to closely follow (i.e., match) the underlying shape of a substrate. The word “with” broadly includes “with, within, inside of, above, and/or below”. The word “airplane” broadly includes propeller-driven airplanes or drones, and jet-engine propelled airplanes (i.e., “jets”). The words “upper” and “lower” refer to vertical positions relative to a normal, steady-state level flight position of an aircraft. The direction indicated by the word “chord”, as it refers to an airplane wing, means parallel to the short direction of the wing. The direction indicated by the word “spanwise”, as it refers to an airplane wing, means parallel to the long (i.e., longitudinal) direction of the wing. The “chord” direction is perpendicular to the “span” direction of the airplane wing.

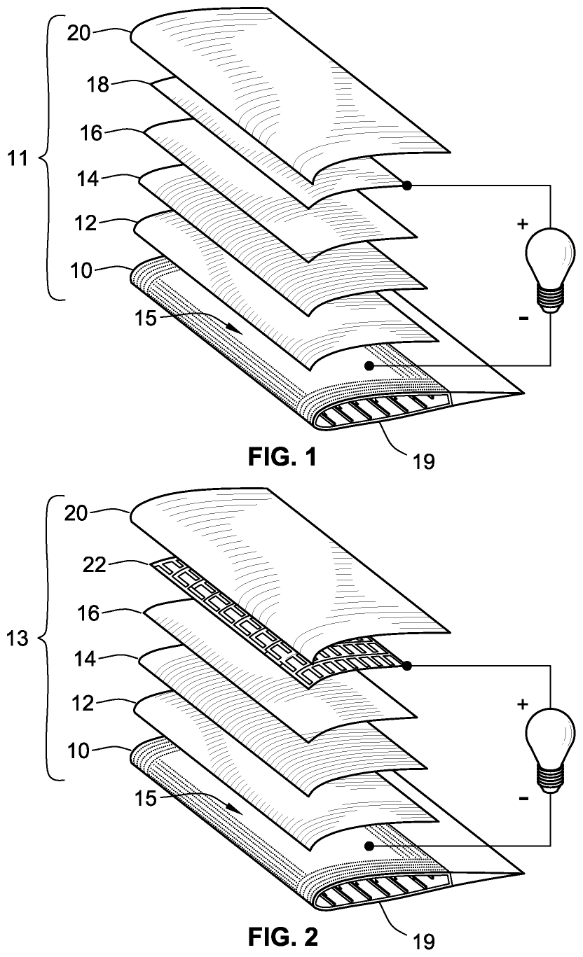

FIG. 1 shows a 3-D perspective view of an example of a structurally-integrated rechargeable battery module 11 that conformally overlays an upper surface 15 of the upper metallic skin 15 of a metallic airplane wing 10, according to the present disclosure. In a first embodiment, the airplane wing 10 is made of a metallic structural material (e.g., aluminum alloy) and has an upper metallic structural skin 15 and a lower metallic structural skin 19. A structurally-integrated rechargeable battery 11 conformally overlays upper metallic structural skin 15 and/or lower metallic structural skin 19. The electrically-conductive, metallic, airplane wing structure 10 itself acts as a cathode (or anode) of the structurally-integrated rechargeable battery. The structurally-integrated rechargeable battery 11 makes innovative use of the upper metallic structural skin 15 and/or lower metallic structural skin 19 as the first conductor of the structurally-integrated rechargeable battery 11. The structurally-integrated rechargeable battery 11 includes six stacked layers, including: first, second, third, fourth, fifth and sixth layers in a possible embodiment. The first layer in this embodiment includes a first conductor 15 (which includes, for example, aluminum or an aluminum alloy) that is the upper (and/or lower) metallic structural skin 15 of the airplane wing 10. The second layer 12 is directly attached to the upper (and/or lower) metallic structural skin 15 and includes a first electrode 12 (which includes, for example, a Lithium-Metal-Oxide electrode). The third layer 14 includes a separator membrane 14 (which includes, for example, a permeable, microporous separator membrane) that is located above the second layer 12. The fourth layer 16 includes a second electrode 16 (which includes, for example, a graphite electrode) that is located above the third layer. The fifth layer 18 includes an electrical conductor 18 (which includes, for example, a copper or copper alloy conductor) that is located above the fourth layer 16. The sixth layer 20 includes a cover material 20 (which includes, for example, paint or a polymeric material) that covers and protects the second conductor layer 18. When a charged, structurally-integrated rechargeable battery 11 is connected to an electrical load (e.g., a motor), then electricity flows through the upper (and/or lower) metallic structural skin 15 from the first layer to a fifth layer. The structurally-integrated rechargeable battery 11 can be, for example, a Lithium-ion (Li-ion) battery in this exemplary implementation.

FIG. 2 shows a 3-D perspective view of an example of a structurally-integrated battery module 13 with a shaped second conductor 22 that conformally overlays the upper metallic skin 15 of a metallic airplane wing 10, according to the present disclosure. This structurally-integrated battery configuration is essentially identical to the example previously shown in FIG. 1, with the exception being that second conductor 22 is specially shaped and patterned to connect multiple rechargeable batteries in series to generate a higher operating voltage (e.g., 12-15 V for ten, 1.2 V Li-ion batteries that are connected in series).

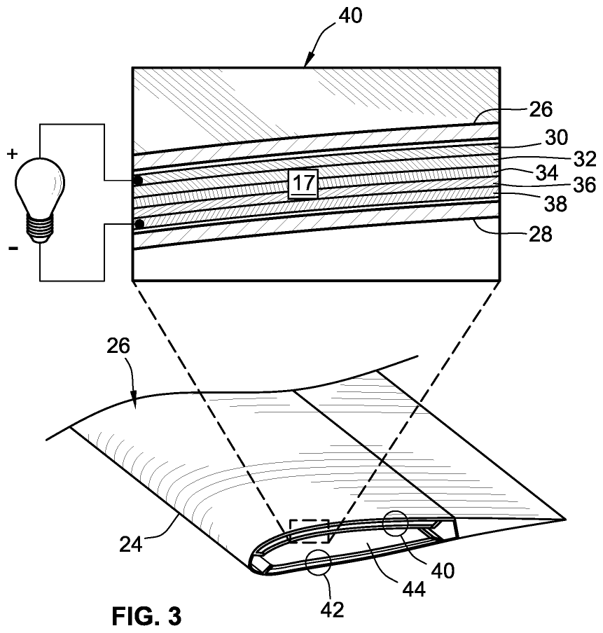

FIG. 3 shows a 3-D perspective view of an example showing a cross-sectional end view of a structurally-integrated battery module 17 that is located inside of an upper composite wing section 40 of a composite airplane wing 24, according to the present disclosure. The close-up view shows an end view of a cross-section of upper composite wing section 40 of composite airplane wing 24, including the structurally-integrated battery 17 disposed inside of the upper composite wing section 40. The upper composite wing section 40 of composite airplane wing 24 includes an upper composite structural skin 26 and an attached, lower internal composite structural laminate layer 28. Structurally-integrated battery 17 is sandwiched in-between upper composite structural skin 26 and internal composite structural laminate layer 28, wherein the multiple battery layers contribute to the overall structural strength of the composite airplane wing 24. Battery 17 replaces the core element 44 (i.e, foam or honeycomb material) of composite airplane wing 24. Battery 17 can include, for example, a Rechargeable lithium-ion battery.

Referring still to FIG. 3, structurally-integrated battery 17 includes multiple, stacked layers, including: a first layer 38 comprising a first conductor 38 disposed above lower composite laminate 28; a second layer 36 comprising a first electrode 36, disposed above first layer 38, a third layer 34 comprising a separator membrane 34, disposed above the second layer 36; a fourth layer 32 comprising a second electrode 32, disposed above the third layer 34; and a fifth layer 30 comprising a second conductor 30, disposed above fourth layer 32. The first conductor 38 can include aluminum or an aluminum alloy. The first electrode 36 can include, for example, a lithium-metal-oxide compound. The separator membrane layer 34 can include, for example, a permeable, microporous separator membrane. The second electrode 32 can include, for example, a graphite electrode. Finally, the second conductor layer 30 can include, for example, copper or a copper alloy.

Referring still to FIG. 3, structurally-integrated rechargeable battery 17 can be disposed inside (not shown) of the lower composite section 42 of composite airplane wing 24. Alternatively (not shown), a pair of structurally-integrated batteries 17, 17′ can be disposed inside both the lower composite section 42 and the upper composite wing section 40 of composite airplane wing 24.

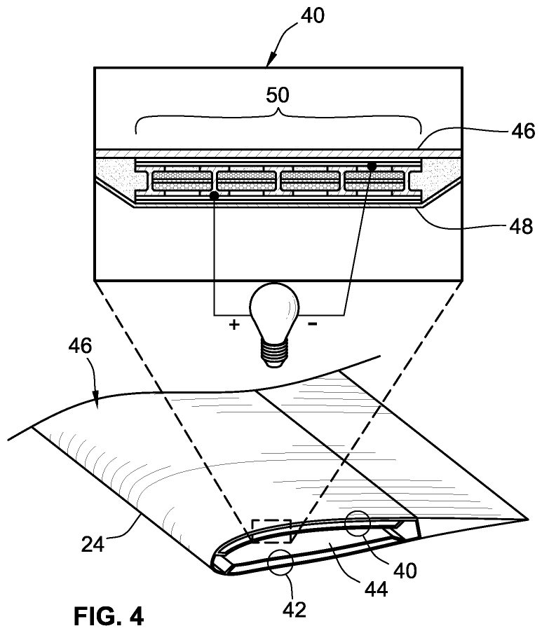

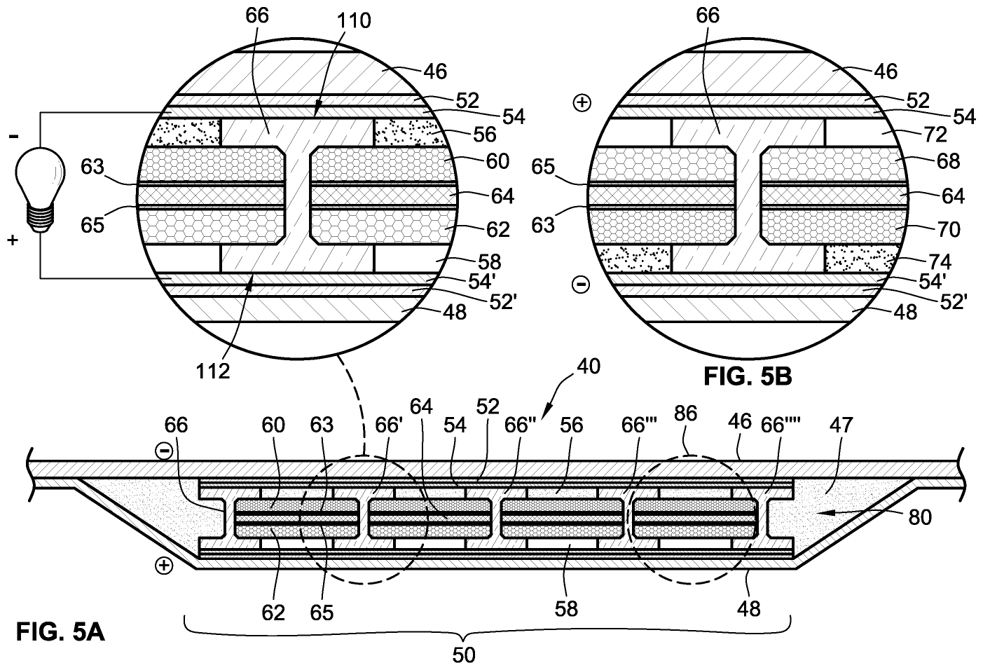

FIG. 4 shows a 3-D perspective view of an example showing a cross-section of a structurally-integrated, rechargeable hydrogen fuel cell module 50 that is located inside of an upper composite airplane wing section 40 of a composite airplane wing 24, according to the present disclosure. The close-up view shows a cross-sectional end view of upper composite airplane wing section 40 of composite airplane wing 24, including the structural hydrogen-fuel cell module 50, which is disposed inside of the upper composite airplane wing section 40 and is sandwiched in-between upper composite structural skin 46 and lower internal composite structural laminate layer 48. The structurally-integrated, rechargeable, hydrogen fuel cell module 50 replaces most, or all, of the conventional “core” 44 (which is typically made of foam or honeycomb material) that is typically located inside of the upper (or lower) composite airplane wing section 40 or 42, respectively of composite airplane wing 24. Additional details of structurally-integrated, rechargeable, hydrogen fuel cell module 50 are presented next in the discussion of FIGS. 5A and 5B.

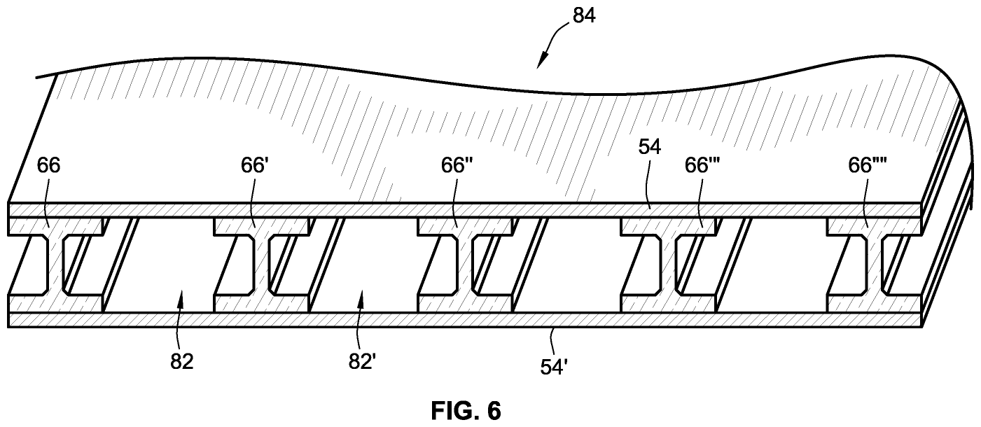

FIG. 5A shows an enlarged, cross-sectional, end view of an example of a structurally-integrated rechargeable hydrogen fuel cell module 50 that is located inside of an upper composite airplane wing section 40 of a composite airplane wing 24 (not illustrated), according to the present disclosure. The structurally-integrated, rechargeable, hydrogen fuel cell module 50 replaces most, or all, of the conventional “core” 44 that is located inside of composite airplane wing 24 (which is typically made of foam or honeycomb material). The individual Hydrogen fuel cells 86 that make up structurally-integrated, rechargeable, hydrogen fuel cell module 50 (e.g., four individual Hydrogen fuel cells 86, 86′, etc. are illustrated in FIG. 5A) contained within a sealed, structural “box” 84 (See FIG. 6), which is defined on four sides by the following attached components: a first, non-conductive, longitudinal stringer 66; a second, non-conductive, longitudinal stringer 66′; an upper metallic cover plate 54 that is disposed across the upper surface 110 of the first and second stringers 66, 66′; and a lower metallic cover plate 54′ disposed across the lower surface 112 of the first and second stringers 66, 66′. The stringers 66, 66′, etc. are oriented parallel to the longitudinal direction of the composite airplane wing. The five stringers 66, 66′, 66″, 66″′, and 66″″ can be made of a glass fiber-reinforced glass composite material, with, for example, primarily unidirectional glass fibers, or woven or non-woven fibers, disposed along the longitudinal direction (i.e., along the length of composite airplane wing 24). The upper and lower metallic cover plates 54 and 54′ can be made of an electrically conductive material, for example, an aluminum alloy or steel. The example shown in FIG. 5A includes five stringers 66, 66′, etc. and four, individual Hydrogen fuel cell bays 82, 82′, etc. (see FIG. 6) that hold the individual Hydrogen fuel cells 86, 86′, etc. that make up Hydrogen fuel cell module 50. The fuel-cell's anode 54 is located above the cathode 54′, in this example.

Referring still to FIG. 5A, structurally-integrated rechargeable hydrogen fuel cell 86 includes eight stacked layers, including (from top to bottom): an upper metallic cover plate 54; an upper, open channel 56 which carries pressurized hydrogen gas; an upper gas diffusion layer 60; an upper (anode) catalyst layer 63; an electrolyte membrane layer 64 (e.g. Proton Exchange Membrane, PEM); a lower (cathode) catalyst layer 65; a lower gas diffusion layer 62; a lower, open channel 58 which carries air; and a lower metallic cover plate 54′. The upper and lower catalyst layers 63 and 65, respectively, can include a catalyst, for example platinum or cobalt-nitrogen-carbon compounds. The upper and lower gas diffusion layers can include, for example, a micro-porous material. The electrolyte membrane 64 can include: a Proton Exchange Membrane, such as Nafion™ or expanded PTFE (ePTFE); a perfluorinated sulfonic acid (PFSA) membrane; or a thin sheet of graphene or boron nitride, and/or combinations thereof. The group of components comprising stacked layers 60, 63, 64, 65, 62 are securely held in-between adjacent longitudinal stringers 66 and 66′, for each individual Hydrogen fuel cell 86. Stringers 66, 66′, etc. can have an I-shaped cross-section or a C-shaped cross-section, depending on their location inside of the wing. Disposed above upper metallic cover plate 54 is a non-conducting, upper cover plate 52, which is made of a non-electrically conducting material, e.g., a glass composite material. Disposed below lower metallic cover plate 54′ is a non-conducting, lower cover plate 52′, which is made of a non-electrically conducting material (e.g., a glass composite material). The space 47 that is located in-between the upper composite structural skin 46 and the lower composite structural laminate 48 can be filled with foam or a honeycomb materials (e.g., aluminum honeycomb).

FIG. 5B shows an enlarged cross-sectional end view of another example of a structurally-integrated rechargeable hydrogen fuel cell module 50 that is located inside of an upper composite airplane wing section 40 of composite airplane wing 24 (not shown), according to the present disclosure. FIG. 5B is very similar to FIG. 5A, with the exception being that each individual Hydrogen fuel cell 86 in FIG. 5B is flipped upside down, with the anode 54′ being located below the cathode 54. In this embodiment, the structurally-integrated rechargeable hydrogen fuel cell 86 includes eight stacked layers, including (from top to bottom): an upper metallic cover plate 54 that serves as the cathode/anode of the H-fuel cell module 50; an upper, open channel 72 which carries pressurized air; an upper gas diffusion layer 68; an upper (cathode) catalyst layer 65; an electrolyte membrane layer 64 (e.g., a Proton Exchange Membrane, PEM); a lower (anode) catalyst layer 63; a lower gas diffusion layer 70; a lower, open channel 74 which carries hydrogen gas; and a lower metallic cover plate 54′ that serves as the cathode/anode of the H-fuel cell module 50.

FIG. 6 shows a schematic, cross-sectional end view of a sealed, structural “box” 84 (Hydrogen fuel cells are not shown) that is located inside of an upper composite section 40 of composite airplane wing 24 (not shown), according to the present disclosure. The individual Hydrogen fuel cells 86, 86′ (not shown) are designed to fit tightly within a sealed structural “box” 84, and are securely held in place by longitudinal stringers 66, 66′, etc. Sealed structural box 84 is defined on four sides by the following attached components: a first, non-conductive, longitudinal stringer 66; a second, non-conductive, longitudinal stringer 66′; an upper metallic cover plate 54; and a lower metallic cover plate 54′. Box 84 is also sealed on both of its longitudinal ends (not shown). The sealed structural box 84 prevents leakage of the hydrogen and air feed gases. The open fuel cell bays 82, 82′, etc. that are disposed inside of sealed structural box 84 include the locations where the individual fuel cells 86, 86′, etc. (not shown) are securely mounted into. Longitudinal stringers 66, 66′, etc. can have an I-shaped cross-section. The first and last longitudinal stringers, 66 and 66″″, that are located at the far ends of the row of longitudinal stringers 66, 66′, etc. can optionally have a C-shaped cross section (not shown).

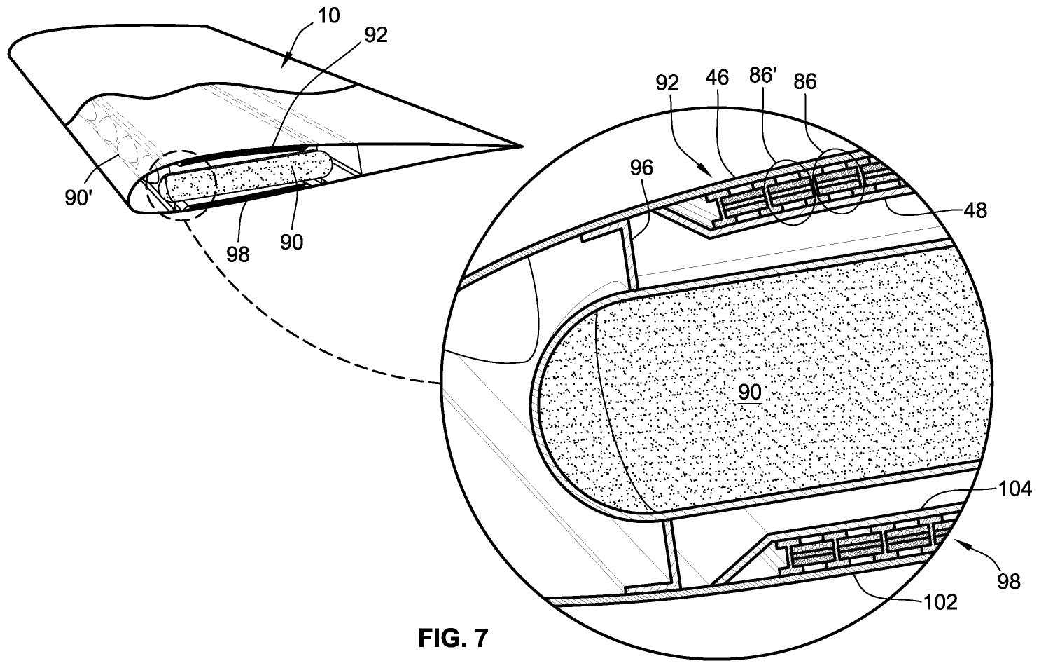

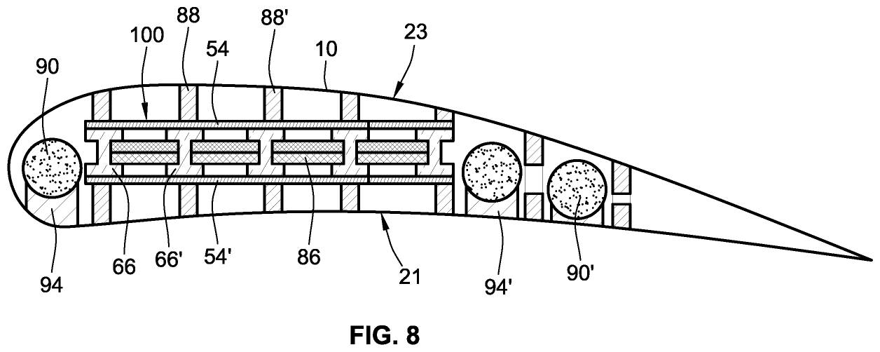

FIG. 7 shows a 3-D perspective, schematic cross-sectional end view of an example of a structurally-integrated upper hydrogen fuel cell module 92; a structurally-integrated lower hydrogen fuel cell module 98 and a representative hydrogen pressure tank 90 that is located inside of a composite airplane wing 24, according to the present disclosure. Pressure tank 90 contains pressurized hydrogen gas. A long direction of hydrogen pressure tank 90 is oriented perpendicular to the longitudinal direction of composite airplane wing 24. Multiple hydrogen pressure tanks 90, 90′, etc. are arranged side-by-side, along the length of wing 24. Mounting brackets 96, 96′ are configured to securely hold hydrogen pressure tanks 90, 90′, respectively inside wing 24. Composite airplane wing 24 further includes an upper hydrogen fuel cell module 92 and a lower hydrogen fuel cell module 98. The lower hydrogen fuel cell module 98 is located in-between the lower (outer) composite structural skin 102 and the upper (internal) composite structural laminate layer 104. The close-up view shown in FIG. 8 illustrates a cross-sectional end view cut through one-half of hydrogen pressure tank 90. In this close-up view, the individual hydrogen fuel cells 86, 86′ of the upper hydrogen fuel cell module 92 are securely held in-between non-conducting, I-shaped, longitudinal stringers 66, 66′, respectively. The same configuration applies to the lower hydrogen fuel cell module 98. Gaseous connections between the hydrogen pressure tank 90 and upper/lower hydrogen fuel cell modules 92 and 98, respectively are not shown.

FIG. 8 shows a 2-D schematic, cross-sectional end view of an example of a structurally-integrated rechargeable hydrogen fuel cell module 100 and a plurality of hydrogen pressure tanks 90, 90′, etc. that are located inside of a metallic airplane wing 10, according to the present disclosure. Metallic airplane wing 10 includes multiple, longitudinal structural ribs 88, 88′, etc. that stiffen metallic airplane wing 10. A structurally-integrated, rechargeable, hydrogen Fuel Cell module 100 is located inside the open space disposed in-between the upper structural skin 23 and the lower structural skin 21 of wing 10. Hydrogen fuel cell module 100 includes: an upper metallic cover plate 54; a lower metallic cover plate 54′; and a plurality of I-shaped, longitudinal stringers 66, 66′, etc. that securely hold hydrogen fuel cells 86, 86′, etc. Longitudinal stringers 66, 66′, etc. are oriented parallel to the longitudinal direction of the metallic airplane wing. Hydrogen fuel cell module 100 is structurally attached within metallic airplane wing 10 by longitudinal structural ribs 88, 88′, etc. A plurality of hydrogen pressure tanks 90, 90′, etc. are disposed inside of wing 10, which are supported by structural brackets 94, 94′, respectively.

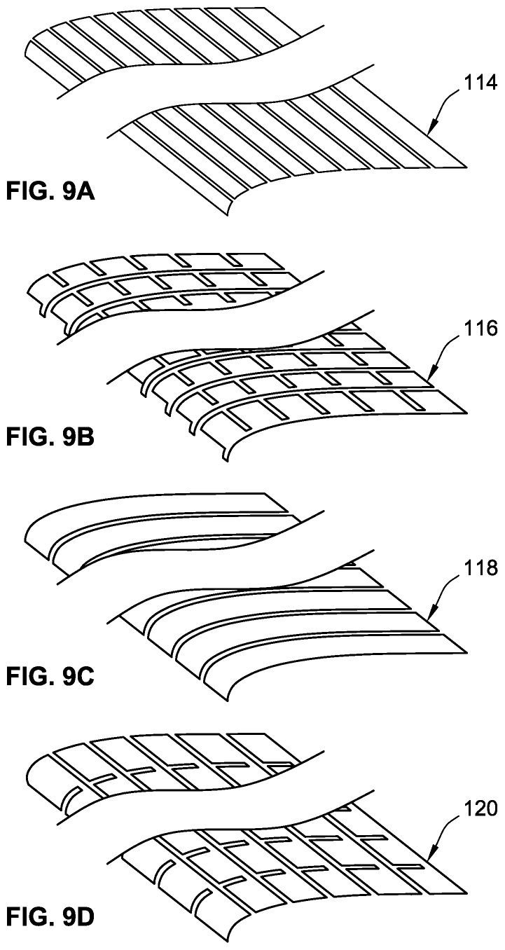

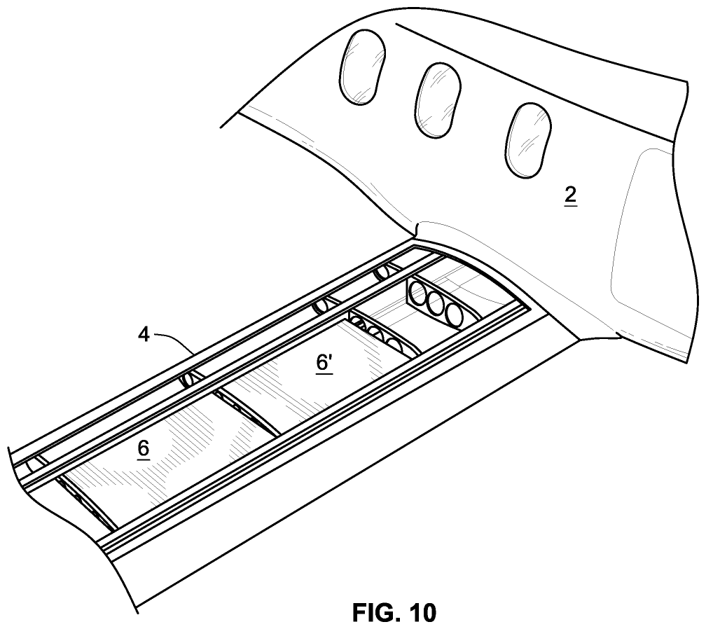

FIG. 9A shows a 3-D perspective view of a first example of a shaped (patterned) conductor layer 114 of the conformal, structurally-integrated rechargeable lithium-ion battery from FIG. 2, which nominally provides 12 V (e.g., 12-15 V auxiliary voltage) for a group of stacked Li-ion battery cells (which produces 1.2 V per each cell), according to the present disclosure.

FIG. 9B shows a 3-D perspective view of a second example of a shaped (patterned) conductor layer 116 of the conformal, structurally-integrated rechargeable lithium-ion battery from FIG. 2, which nominally provides 12 V (e.g., 12-15 V auxiliary voltage) for a group of stacked Li-ion battery cells (which produces 1.2 V per each cell), according to the present disclosure.

FIG. 9C shows a 3-D perspective view of a third example of a shaped (patterned) conductor layer 118 of the conformal, structurally-integrated rechargeable lithium-ion battery from FIG. 2, which nominally provides 12 V (e.g., 12-15 V auxiliary voltage) for a group of stacked Li-ion battery cells (which produces 1.2 V per each cell), according to the present disclosure.

FIG. 9D shows a 3-D perspective view of a fourth example of a shaped (patterned) conductor layer 120 of the conformal, structurally-integrated rechargeable lithium-ion battery from FIG. 2, which nominally provides 12 V (e.g., 12-15 V auxiliary voltage) for a group of stacked Li-ion battery cells (which produces 1.2 V per each cell), according to the present disclosure.

FIG. 10 shows a 3-D perspective view of an airplane 2 with an airplane wing 4 and structurally-integrated power sources 6, 6′, according to the present disclosure. Airplane wing 4 can be a metallic wing or a composite wing. Structurally-integrated power sources 6, 6′ can be a rechargeable battery or a rechargeable hydrogen fuel cell.

The following Clauses provide example configurations of a method and system for replacing traditional fuel tanks in an airplane wing with structurally-integrated rechargeable power sources.

Clause 1: An aerospace structure, comprising an airplane comprising an airplane wing; and a structurally-integrated rechargeable power source that is structurally-integrated with the airplane wing.

Clause 2: The aerospace structure of clause 1, wherein the airplane wing is made of a metallic structural material; wherein the airplane wing comprises an upper metallic skin and a lower metallic skin; and wherein the structurally-integrated rechargeable power source comprises a structurally-integrated rechargeable battery that conformally overlays the upper metallic skin of the airplane wing and/or the lower metallic skin of the airplane wing.

Clause 3: The aerospace structure of clause 1, wherein the airplane wing comprises an outer composite structural skin and an internal composite structural laminate; and wherein the structurally-integrated rechargeable power source comprises a rechargeable battery that is disposed in-between the outer composite structural skin and the internal composite structural laminate.

Clause 4: The aerospace structure of clause 1, wherein the airplane wing comprises an upper structural skin and a lower structural skin; and wherein the structurally-integrated rechargeable power source comprises a structurally-integrated, rechargeable hydrogen fuel cell that is disposed in-between the upper structural skin and the lower structural skin of the airplane wing.

Clause 5: The aerospace structure of clause 4, wherein the upper structural skin and the lower structural skin are metallic.

Clause 6: The aerospace structure of clause 4, wherein the upper structural skin and the lower structural skin are made of a composite material.

Clause 7: An aerospace structure, comprising: an airplane wing comprising a metallic airplane wing comprising a metallic structural skin; and a structurally-integrated rechargeable battery that is structurally-integrated with the airplane wing; wherein the structurally-integrated rechargeable battery comprises a plurality of stacked layers, comprising: a first conductor layer comprising the metallic structural skin of the airplane wing; a second layer directly attached to the metallic structural skin, wherein the second layer comprises a first electrode; a third layer disposed above the second layer, wherein the third layer comprises a separator membrane; a fourth layer disposed above the third layer, wherein the fourth layer comprises a second electrode; and a fifth layer disposed above the fourth layer, wherein the fifth layer comprises a second electrical conductor; wherein electricity flows through the metallic structural skin from the first layer of the structurally-integrated rechargeable battery to the fifth layer of the structurally-integrated rechargeable battery, when a charged structurally-integrated rechargeable battery is connected to an electrical load.

Clause 8: The aerospace structure of claim 7, wherein the structurally-integrated rechargeable battery conformally overlays an upper metallic skin of the airplane wing.

Clause 9. The aerospace structure of claim 7, wherein the structurally-integrated rechargeable battery conformally overlays a lower metallic skin of the airplane wing.

Clause 10: The aerospace structure of claim 7, wherein the structurally-integrated rechargeable battery comprises a structurally-integrated rechargeable lithium-ion battery.

Clause 11: The aerospace structure of claim 10, wherein the first electrode comprises a Lithium-Metal-Oxide compound.

Clause 12: The aerospace structure of claim 7, further comprising: a cover layer disposed on the fifth layer of the structurally-integrated rechargeable battery; wherein the cover layer comprises paint and/or a polymeric material.

Clause 13: The aerospace structure of claim 7, wherein the second electrical conductor of the fifth layer is shaped and patterned to electrically connect multiple lithium-ion batteries in series to provide a higher operating voltage.

Clause 14: An aerospace structure, comprising: an airplane comprising a composite airplane wing; and a structurally-integrated rechargeable power source that is structurally-integrated inside of the composite airplane wing; wherein the composite airplane wing comprises an outer composite structural skin and an internal composite structural laminate; and wherein the structurally-integrated rechargeable power source is sandwiched in-between the outer composite structural skin and the internal composite structural laminate.

Clause 15: The aerospace structure of claim 14, wherein the structurally-integrated rechargeable power source comprises a structurally-integrated rechargeable lithium-ion battery; and wherein the structurally-integrated rechargeable lithium-ion battery comprises: a first layer disposed inside of the composite airplane wing, wherein the first layer comprises a first conductor comprising copper or a copper alloy; a second layer disposed above the first layer, wherein the second layer comprises a first electrode comprising a Li-M-O compound; a third layer disposed above the second layer, wherein the third layer comprises a separator membrane; and a fourth layer disposed above the third layer, wherein the fourth layer comprises a second electrode comprising graphite; and a fifth layer disposed above the fourth layer, wherein the fifth layer comprises a second conductor comprising copper or a copper alloy; wherein electricity flows from the first layer of the structurally-integrated rechargeable lithium-ion battery to the fifth layer of the structurally-integrated rechargeable lithium-ion battery, when a charged structurally-integrated rechargeable lithium-ion battery is connected to an electrical load.

Clause 16: The aerospace structure of claim 14, wherein the structurally-integrated rechargeable power source comprises a structurally-integrated rechargeable hydrogen fuel cell module.

Clause 17: The aerospace structure of claim 16, wherein the structurally-integrated rechargeable hydrogen fuel cell module comprises: a plurality of longitudinal stringers that are oriented parallel to a longitudinal direction of the airplane wing, wherein each longitudinal stringer comprises an upper surface and a lower surface; an upper metallic cover plate disposed across the upper surface of the longitudinal stringers; a lower metallic cover plate disposed across the lower surface of the longitudinal stringers; a sealed structural box defined on four sides by: the upper metallic cover plate, the lower metallic cover plate, and the plurality of longitudinal stringers; and multiple stacked layers of the structurally-integrated rechargeable hydrogen fuel cell module, disposed inside of the sealed structural box, wherein the multiple stacked layers comprise: a first layer comprising a first, open longitudinal channel that carries air inside of the structurally-integrated rechargeable hydrogen fuel cell module; a second layer, disposed above the first layer, comprising a first diffusion layer; a third layer, disposed above the second layer, comprising a first catalyst layer; a fourth layer, disposed above the third layer, comprising an electrolyte membrane; a fifth layer, disposed above the fourth layer, comprising a second catalyst layer; a sixth layer, disposed above the fifth layer, comprising a second diffusion layer; and a seventh layer, disposed above the sixth layer, comprising a second, open, longitudinal channel that carries hydrogen gas inside of the structurally-integrated rechargeable hydrogen fuel cell module.

Clause 18: The aerospace structure of claim 17, wherein the electrolyte membrane comprises a material selected from the group consisting of a Proton Exchange Material (PEM), a perfluorinated sulfonic acid material (PFSA), graphene, boron nitride, and combinations thereof.

Clause 19: The aerospace structure of claim 17, wherein the plurality of longitudinal stringers has an I-shaped cross-section; and wherein the longitudinal stringers are made of a glass-fiber reinforced glass composite material.

Clause 20: The aerospace structure of claim 16, further comprising at least one pressure tank, disposed inside of the composite airplane wing, that contains pressurized hydrogen gas.

In other embodiments, rechargeable Metal-Air batteries can be used (e.g., Ti-Air, Zn-Air, Al-Air, Fe-Air, and/or Si-Air batteries).

Aspects of the present disclosure have been described in detail with reference to the illustrated embodiments. Those skilled in the art will recognize, however, that many modifications may be made thereto without departing from the scope of the present disclosure. The present disclosure is not limited to the precise construction and compositions disclosed herein. Any and all modifications, changes, and variations apparent from the foregoing descriptions are within the scope of the disclosure as defined by the appended claims. Moreover, the present concepts expressly include any and all combinations and sub-combinations of the preceding elements and features.

What is claimed is:

1. An aerospace structure, comprising
an airplane comprising an airplane wing; and
a structurally-integrated rechargeable power source that is structurally-integrated with the airplane wing.

2. The aerospace structure of claim 1,
wherein the airplane wing is made of a metallic structural material;
wherein the airplane wing comprises an upper metallic skin and a lower metallic skin; and
wherein the structurally-integrated rechargeable power source comprises a structurally-integrated rechargeable battery that conformally overlays the upper metallic skin of the airplane wing and/or the lower metallic skin of the airplane wing.

3. The aerospace structure of claim 1,
wherein the airplane wing is a composite wing that comprises an outer composite structural skin and an internal composite structural laminate; and
wherein the structurally-integrated rechargeable power source comprises a rechargeable battery that is disposed in-between the outer composite structural skin and the internal composite structural laminate.

4. The aerospace structure of claim 1,
wherein the airplane wing comprises an upper structural skin and a lower structural skin; and
wherein the structurally-integrated rechargeable power source comprises a structurally-integrated, rechargeable hydrogen fuel cell that is disposed in-between the upper structural skin and the lower structural skin of the airplane wing.

5. The aerospace structure of claim 4, wherein the upper structural skin and the lower structural skin are metallic.

6. The aerospace structure of claim 4, wherein the upper structural skin and the lower structural skin are made of a composite material.

7. An aerospace structure, comprising:
an airplane wing comprising a metallic airplane wing comprising a metallic structural skin; and
a structurally-integrated rechargeable battery that is structurally-integrated with the airplane wing;
wherein the structurally-integrated rechargeable battery comprises a plurality of stacked layers, comprising;
a first conductor layer comprising the metallic structural skin of the metallic airplane wing;
a second layer directly attached to the metallic structural skin, wherein the second layer comprises a first electrode;
a third layer disposed above the second layer, wherein the third layer comprises a separator membrane;
a fourth layer disposed above the third layer, wherein the fourth layer comprises a second electrode; and
a fifth layer disposed above the fourth layer, wherein the fifth layer comprises a second electrical conductor;
wherein electricity flows through the metallic structural skin from the first layer of the structurally-integrated rechargeable battery to the fifth layer of the structurally-integrated rechargeable battery when a charged structurally-integrated rechargeable battery is connected to an electrical load.

8. The aerospace structure of claim 7, wherein the structurally-integrated rechargeable battery conformally overlays an upper metallic skin of the airplane wing.

9. The aerospace structure of claim 7, wherein the structurally-integrated rechargeable battery conformally overlays a lower metallic skin of the airplane wing.

10. The aerospace structure of claim 7, wherein the structurally-integrated rechargeable battery comprises a structurally-integrated rechargeable lithium-ion battery.

11. The aerospace structure of claim 10, wherein the first electrode comprises a Lithium-Metal-Oxide compound.

12. The aerospace structure of claim 7, further comprising:
a cover layer disposed on the fifth layer of the structurally-integrated rechargeable battery;
wherein the cover layer comprises paint and/or a polymeric material.

13. The aerospace structure of claim 7, wherein the second electrical conductor of the fifth layer is shaped and patterned to electrically connect multiple lithium-ion batteries in series to provide a higher operating voltage.

14. An aerospace structure, comprising:
an airplane comprising a composite airplane wing; and
a structurally-integrated rechargeable power source that is structurally-integrated inside of the composite airplane wing;
wherein the composite airplane wing comprises an outer composite structural skin and an internal composite structural laminate; and
wherein the structurally-integrated rechargeable power source is sandwiched in-between the outer composite structural skin and the internal composite structural laminate.

15. The aerospace structure of claim 14,
wherein the structurally-integrated rechargeable power source comprises a structurally-integrated rechargeable lithium-ion battery; and
wherein the structurally-integrated rechargeable lithium-ion battery comprises:
a first layer disposed inside of the composite airplane wing, wherein the first layer comprises a first conductor comprising copper or a copper alloy;
a second layer disposed above the first layer, wherein the second layer comprises a first electrode comprising a Li-M-O compound;
a third layer disposed above the second layer, wherein the third layer comprises a separator membrane;
a fourth layer disposed above the third layer, wherein the fourth layer comprises a second electrode comprising graphite; and
a fifth layer disposed above the fourth layer, wherein the fifth layer comprises a second conductor comprising copper or a copper alloy;
wherein electricity flows from the first conductor of the structurally-integrated rechargeable lithium-ion battery to the second conductor of the structurally-integrated rechargeable lithium-ion battery when a charged structurally-integrated rechargeable lithium-ion battery is connected to an electrical load.

16. The aerospace structure of claim 14, wherein the structurally-integrated rechargeable power source comprises a structurally-integrated rechargeable hydrogen fuel cell module.

17. The aerospace structure of claim 16, wherein the structurally-integrated rechargeable hydrogen fuel cell module comprises:
a plurality of longitudinal stringers that are oriented parallel to a longitudinal direction of the airplane wing, wherein each one of the plurality of longitudinal stringers comprises an upper surface and a lower surface;
an upper metallic cover plate disposed across the upper surface of each one of the plurality of longitudinal stringers;
a lower metallic cover plate disposed across the lower surface of each one of the plurality of longitudinal stringers;
a sealed structural box defined on four sides by: the upper metallic cover plate, the lower metallic cover plate, and the plurality of longitudinal stringers; and
multiple stacked layers of the structurally-integrated rechargeable hydrogen fuel cell module, disposed inside of the sealed structural box, wherein the multiple stacked layers comprise:
a first layer comprising a first, open longitudinal channel that carries air inside of the structurally-integrated rechargeable hydrogen fuel cell module;
a second layer, disposed above the first layer, comprising a first diffusion layer;
a third layer, disposed above the second layer, comprising a first catalyst layer;
a fourth layer, disposed above the third layer, comprising an electrolyte membrane;
a fifth layer, disposed above the fourth layer, comprising a second catalyst layer;
a sixth layer, disposed above the fifth layer, comprising a second diffusion layer; and
a seventh layer, disposed above the sixth layer, comprising a second, open longitudinal channel that carries hydrogen gas inside of the structurally-integrated rechargeable hydrogen fuel cell module.

18. The aerospace structure of claim 17, wherein the electrolyte membrane comprises a material selected from the group consisting of a Proton Exchange Material (PEM), a perfluorinated sulfonic acid material (PFSA), graphene, boron nitride, and combinations thereof.

19. The aerospace structure of claim 17,
wherein the plurality of longitudinal stringers has an I-shaped cross-section; and
wherein the plurality of longitudinal stringers are made of a glass-fiber reinforced glass composite material.

20. The aerospace structure of claim 16, further comprising at least one pressure tank, disposed inside of the composite airplane wing that contains pressurized hydrogen gas.
